(19) United States
(12) Patent Application Publication
(10) Pub. No.: US 2007/0222536 A1
(43) Pub. Date: Sep. 27, 2007

(54) Loss compensation circuit

(76) Inventor: Chih-Ming Yang, Taipei (TW)

Correspondence Address: PEARL COHEN ZEDEK LATZER, LLP, 1500 BROADWAY 12TH FLOOR, NEW YORK, NY, 10036, US

(21) Appl. No.: 11/387,899

(22) Filed: Mar. 24, 2006

(51) Int. Cl. H04B 3/14; H01P 9/00; H04L 25/03

(52) U.S. Cl. 333/28 R

(57) ABSTRACT

A loss compensation circuit, which is applicable to a printed circuit board (PCB) having a plurality of signal transmission lines, includes a first conductive segment, a loss compensation module and a second conductive segment. The first conductive segment has a length shorter than one inch, and a front end for connecting to one of the signal transmission lines of the PCB. The loss compensation module is connected to a rear end of the first conductive segment. The second conductive segment has a rear end connected to the loss compensation module, and a front end for connecting to another one of the signal transmission lines of the PCB. Therefore, signals transmitted over the signal transmission lines of the PCB, even having different signal frequencies, will have substantially equal signal losses, and are easier to be interpreted.

### BACKGROUND OF THE INVENTION

1. Field of the Invention

This invention relates to a loss compensation circuit, and more particularly, to a loss compensation circuit having a first conductive segment for connecting to one of a plurality of signal transmission lines of a printed circuit board (PCB), the first conductive segment having a length shorter than one inch.

2. Description of Related Art

In a digital communications system, digital signals are modulated into analog signals, and the analog signals (called symbols) are transmitted independently, without interfering to one another. The analog signals, after received by a signal receiving end, are ideally demodulated back to their original digital signals. However, in reality the analog signals will interfere to one another due to channel distortion, and the signal receiving end will receive nothing but interfered analog signals, which are hardly interpreted. Such a scenario is called inter-symbol interference (ISI).

For example, in a wireless communications system signals are emitted by a signal transmitting end. A signal receiving end will receive the signals (hereinafter called direct signals) directly emitted from the signal transmitting end, and signals (hereinafter called indirect signals) corresponding to the direct signals and indirectly transmitted via an indirect transmission path different from a direct transmission path via which the direct signals are directly transmitted from the signal transmitting end to the signal receiving end. Because the direct transmission path is different from the indirect transmission path, the time for the direct and indirect signals to the signal receiving end are different. In result, if the signal transmitting end emits one million analog signals per second, and each of the analog signals has therefore a time interval of one micro seconds, the signal receiving end is likely to receive at the same time two signals having time intervals having a difference of one micro second. These two signals overlap and interfere each other. Such an ISI due to the multi-path is called multi-path ISI.

A multiple-layered printed circuit board (PCB) is a circuit having a plurality of signal transmission lines. Electrical losses generated by the signal transmission lines dominate the formation of the ISI.

Several methods are proposed to solve the ISI problem of the PCB; the first one is adopting a material with less electrical loss to serve as a filling material of the PCB; the second one is adopting wide lines to serve as the signal transmission lines of the PCB. However, the material with less electrical loss costs high, and the wide lines have to occupy a large area of the PCB, so both of the methods increase manufacturing cost.

FIG. 1 is a circuit diagram of a loss compensation circuit 1 according to the prior art. The loss compensation circuit 1 is connected in series with one of the signal transmission lines of the PCB. However, the loss compensation circuit 1 is complicated. To reduce the ISI, the loss compensation circuit 1 has to comprise three resistors R1, R2 and R3, one capacitor C1, and one inductor L1. Therefore, the loss compensation circuit 1 costs high, and has to occupy a large area of the PCB and is hard to be installed on the PCB.

Therefore, how to provide a low-cost loss compensation circuit easy to be implemented on a multiple-layered PCB is becoming one of the most important R&D issues in the art.

### SUMMARY OF THE INVENTION

In views of the above-mentioned problems of the prior art, it is a primary objective of the present invention to provide a loss compensation circuit for keeping signals, even having different signal frequencies, to still have approximately equal electrical losses, so as to reduce the ISI.

It is another objective of the present invention to provide a loss compensation circuit for generating signals easier to be interpreted.

It is a further objective of the present invention to provide a loss compensation circuit of low cost.

It is still another objective of the present invention to provide a loss compensation circuit easier to be implemented on a multiple-layered printed circuit board.

To achieve the above-mentioned and other objectives, a loss compensation circuit is provided according to the present invention. The loss compensation circuit is applicable to a printed circuit board (PCB) having a plurality of signal transmission lines, and includes a first conductive segment, a loss compensation module and a second conductive segment. The first conductive segment has a length shorter than one inch, and a front end for connecting to one of the signal transmission lines of the PCB. The loss compensation module is connected to a rear end of the first conductive segment. The second conductive segment has a rear end connected to the loss compensation module, and a front end for connecting to another one of the signal transmission lines of the PCB. Therefore, signals transmitted over the signal transmission lines of the PCB, even having different signal frequencies, will have substantially equal signal losses, and are easier to be interpreted.

According to the preferred embodiment, the PCB is a double- or multiple-layered PCB; the one of the signal transmission lines is connected to the another one of the signal transmission lines; the loss compensation module comprises a capacitor and a resistor.

Compared with the prior art, the loss compensation circuit of the present invention is to achieve the above-mentioned and other objectives by connecting a loss compensation module with a first conductive segment having a length shorter than one inch.

### BRIEF DESCRIPTION OF DRAWINGS

The invention can be more fully understood by reading the following detailed description of the preferred embodiments, with reference made to the accompanying drawings, wherein:

FIG. 1 is a circuit diagram of a loss compensation circuit according to the prior art;

FIG. 2 is a circuit diagram of a loss compensation circuit of the preferred embodiment according to the present invention;

FIG. 3 is a waveform diagram of three signals S1, S2 and S3 transmitted over signal transmission lines of a PCB;

FIGS. 4 and 5 are two eye diagrams of two differential signals transmitted over one of the signal transmission lines of the PCB and having traveled through the loss compensation circuit shown in FIG. 2 respectively; and

FIGS. 6, 7 and 8 are another three eye diagrams illustrating the signals having traveled through the loss compensation circuit, where a first conductive segment of the loss compensation circuit has a length of 500, 1,000, and 1,500 mils respectively.

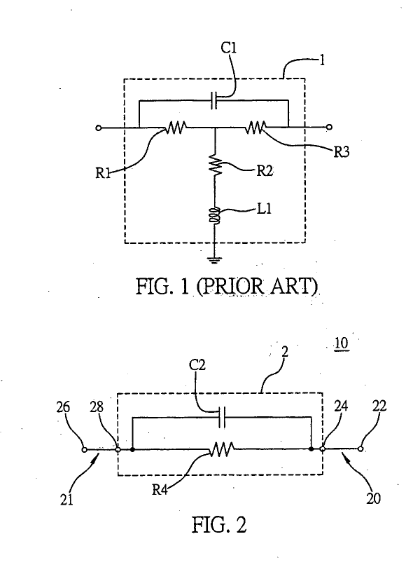

### DETAILED DESCRIPTION OF PREFERRED EMBODIMENTS

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

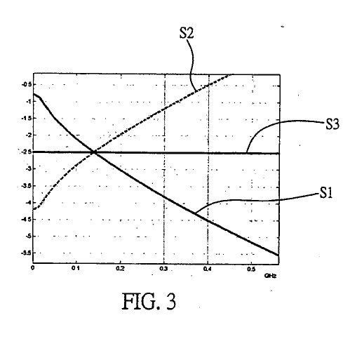

FIGS. 2-8 are seven simplified schematic diagrams corresponding to a loss compensation circuit 10 of the preferred embodiment according to the present invention. Note that only components and tables related to the present invention are shown in FIGS. 2-8, and the components are drawn schematically and are not as shown in practice.

FIG. 2 is a circuit diagram of the loss compensation circuit 10. The loss compensation module 2 is applicable to a double- or multiple-layered printed circuit board (PCB) comprising a plurality signal transmission lines. The loss compensation circuit 10 comprises a first conductive segment 20, a loss compensation module 2 and a second conductive segment 21. The first conductive segment has a length shorter than one inch, and a front end 22 for connecting to one of the signal transmission lines of the PCB. The loss compensation module 2 is connected to a rear end 24 of the first conductive segment 20. The second conductive segment 21 has a rear end 28 connected to the loss compensation module 2, and a front end 26 for connecting to another one of the signal transmission lines of the PCB. Therefore, signals transmitted over the signal transmission lines of the PCB, even having different signal frequencies, will have substantially equal signal losses, and are easier to be interpreted.

According to the preferred embodiment, the one of the signal transmission lines is not connected to the another one of the signal transmission lines, and the loss compensation circuit 10 is in equivalence to be connected in series with two signal transmission lines of the PCB. Alternatively, the loss compensation circuit 10 can be connected in parallel to one of the signal transmission lines of the PCB. In such an scenario, the one of the signal transmission lines is connected to the another one of the signal transmission lines.

According to the preferred embodiment, the loss compensation module 2 comprises a resistor R4 and a capacitor C2 connected in parallel to the resistor R4, both of which are used to compensate the ISI. Of another loss compensation circuit of the present invention, the resistor R4 can be connected in series with the capacitor C2.

The loss compensation circuit 10 of the present invention is used for reducing the ISI, which has been described in the prior art and is hereby omitted. By performing a channel equalization process on modulated and distorted analog signals, the loss compensation circuit 10 compensates and reduces the ISI resulted from the electrical losses of the PCB. Therefore, the modulated analog signals are likely to be demodulated back to their original digital signals, and are easier to be interpreted by succeeding processes.

FIG. 3 is a waveform diagram of three signals S1, S2 and S3 transmitted over the signal transmission lines of the PCB, where an ordinate represents electrical losses of these signals, and an abscissa represents signal frequencies of these signals. The signal S1 is a signal transmitted over one of signal transmission lines of the PCB. It can be seen in FIG. 3 that the signal S1 has an electrical loss varying with its signal frequencies, and decreasing as the signal frequency increases. The signal S2 is a signal formed by the loss compensation circuit 10 and used to compensate the signal S1. The signal S3 is a combination of the signals S1 and S2, and has an electrical loss invariant with the signal frequencies. In result, any signals first transmitted over the signal transmission lines of the PCB and then traveling through the loss compensation circuit 10 will have substantially equal electrical losses under different signal frequencies, and are therefore immune from the ISI.

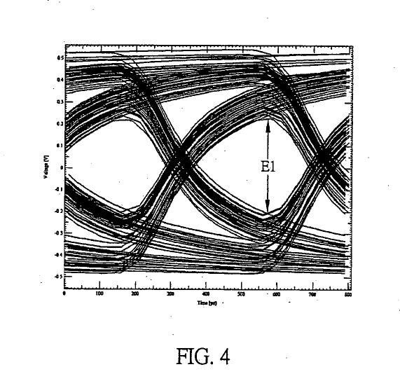

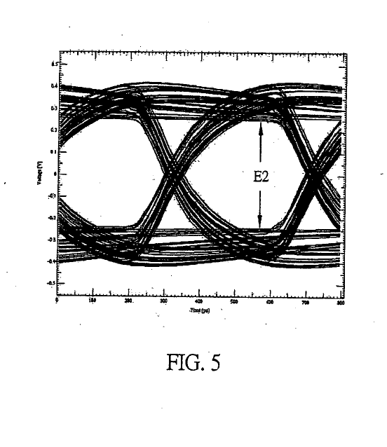

FIGS. 4 and 5 are two eye diagrams of two differential signals (each of which has an input amplitude of 0.2-0.8 volts, 2.5 Gb/ps between a positive end and a negative end) transmitted over one of the signal transmission lines (the signal transmission line is equal to 80 inches in length, and W/D=9 mils/18 mils) of the PCB and having traveled through the loss compensation circuit 10 respectively. The length of the first conductive segment 20 is approximately equal to one inch, the capacitor C2 has a capacitance of 19 pF, and the resistor R4 has a resistance of 56 ohms.

It can be seen in FIGS. 4 and 5 that the signal (shown in FIG. 5) having traveled through the loss compensation circuit 10 has an eye opening amplitude E2 larger than another eye opening amplitude E1 of the signal (shown in FIG. 4) transmitted over the signal transmission lines of the PCB. Therefore, the ISI is reduced, and the differential signals having traveled through the loss compensation circuit 10 are not distorted and are easier to be interpreted by the succeeding processes.

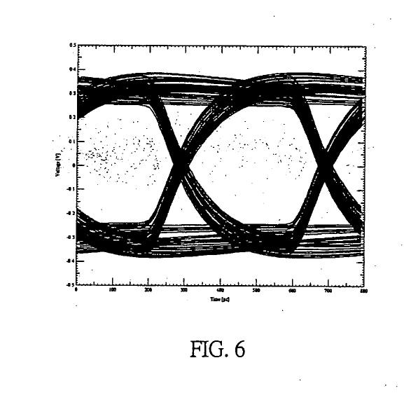

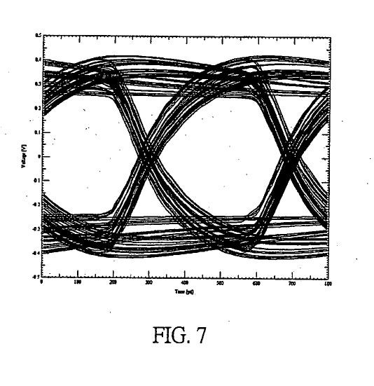

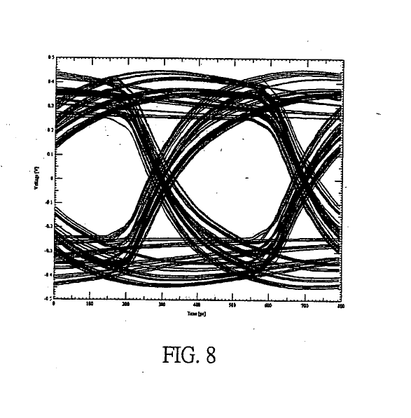

FIGS. 6, 7 and 8 are another three eye diagrams illustrating the signals having traveled through the loss compensation circuit 10, where the first conductive segment 20 has a length of 500, 1,000, and 1,500 mils respectively. It can be seen in these figures that the signals shown in FIGS. 6 and 7 have approximately equal eye opening amplitudes, and both of the eye opening amplitudes are larger than an eye opening amplitude of the signal shown in FIG. 8. In conclusion, the ISI is more server on the loss compensation circuit 10 if the first conductive segment 20 is 1,500 mils, which is longer than one inch.

Therefore, if the first conductive segment 20 has a length shorter than one inch, the loss compensation circuit 10 will perform a very satisfied ISI-reducing effect.

In contrast to the prior art, the loss compensation circuit of the present invention comprises a first conductive segment, a loss compensation module and a second conductive segment. The first conductive segment has a length shorter than one inch, and a front end for connecting to one of the signal transmission lines of the PCB. The loss compensation module is connected to a rear end of the first conductive segment. The second conductive segment has a rear end connected to the loss compensation module, and a front end for connecting to another one of the signal transmission lines of the PCB. Therefore, signals transmitted over the signal transmission lines of the PCB, even having different signal frequencies, will have substantially equal signal losses, and are easier to be interpreted. Moreover, compared with the prior art, the loss compensation circuit has fewer components, and has a low cost and is easier to be implemented on a multiple-layered PCB.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A loss compensation circuit applicable to a printed circuit board (PCB) having a plurality of signal transmission lines, the loss compensation circuit comprising:
a first conductive segment having a length shorter than one inch, and a front end for connecting to one of the signal transmission lines of the PCB;
a loss compensation module connected to a rear end of the first conductive segment; and
a second conductive segment having a rear end connected to the loss compensation module, and a front end for connecting to another one of the signal transmission lines of the PCB.

2. The loss compensation circuit of claim 1, wherein the PCB is a multiple-layered PCB.

3. The loss compensation circuit of claim 2, wherein the multi-layered PCB is a double-layered PCB.

4. The loss compensation circuit of claim 1, wherein the one of the signal transmission lines is connected to the another one of the signal transmission lines.

5. The loss compensation circuit of claim 1, wherein the loss compensation module comprises a resistor and a capacitor.

6. The loss compensation circuit of claim 5, wherein the resistor is connected in series with the capacitor.

7. The loss compensation circuit of claim 5, wherein the resistor is connected in parallel to the capacitor.

8. The loss compensation circuit of claim 7, wherein the resistor has a resistance of 56 ohms, and the capacitor has a capacitance of 19 pF.

9. The loss compensation circuit of claim 1, wherein the first conductive segment is equal to 500 mils in length.
